(19) United States
(12) Patent Application Publication
(10) Pub. No.: US 2012/0027329 A1
(43) Pub. Date: Feb. 2, 2012

(54) FLANGE ASSEMBLY

(76) Inventor: Franck Landrieve, Fondettes (FR)

(21) Appl. No.: 13/262,878

(22) PCT Filed: Apr. 7, 2009
(86) PCT No.: PCT/IB2009/052782

§ 371 Date: Oct. 4, 2011

(51) Int. Cl. F16C 32/00

(52) U.S. Cl. 384/448

(57) ABSTRACT

This flange assembly (1), for holding a shaft (2), comprises:
a rolling bearing (3) with the inner ring (31) rotatable around an axis (X₃-X′₃),
a target (51) attached to the inner ring (31),
a sensing element (7),
a flange (4) having securing means (41, 42) for securing said flange assembly (1) to a static casing (C).

The flange assembly (1) further comprises:
a holding part (43) to hold the outer ring (32),
a resilient part (44) to elastically urge said holding part (43) with respect to the securing means (41, 42) and along said axis (X₃-X′₃).

The sensing element (7) is attached to the holding part (43) so as to be removable from outside said static casing (C).

### TECHNICAL FIELD OF THE INVENTION

The present invention relates to a flange assembly for holding a portion of a rotatable shaft.

### BACKGROUND ART OF THE INVENTION

EP-A-1 705 089 describes a flange assembly comprising a ball bearing, a target attached to an inner ring of the ball bearing, a sensor and a flange for securing the outer ring of the ball bearing to a static casing. In the flange assembly, the sensor can hardly be removed in order to be replaced or repaired. Furthermore, the ball bearing of the flange assembly of EP-A-1 705 089 has a relatively low service life due to the axial clearance between rotating parts and static parts. Besides, the sensor and the target may have separate movements, such that the sensing gap between them varies, thus lowering the sensor accuracy.

### SUMMARY OF THE INVENTION

One object of the present invention is to solve the here-above described problems by providing a flange assembly enabling access to the sensor, hence a high serviceability, and allowing axial preloading of the rolling bearing.

This object is achieved by a flange assembly, for holding a portion of a rotatable shaft, comprising:
a rolling bearing having an inner ring and an outer ring, said inner ring being rotatable around an axis of rotation,
a target attached to said inner ring,
a sensing element arranged to read said target,
a flange having securing means for securing said flange assembly to a static casing.
   This flange assembly is characterized in that it further comprises:
a holding part configured to hold said outer ring,
a resilient part arranged to elastically urge said holding part with respect to said securing means and generally along said axis of rotation,
   Furthermore, said sensing element is attached to said holding part so as to be removable from outside said static casing.

Thanks to the invention, the sensor is easily removable, the rolling bearing can be preloaded and the sensor and the target move together without significantly varying the sensing gap between them.

According to other advantageous but optional features of the present invention, considered either in isolation or in any technically feasible combination:
said resilient part is integral with said flange;
said holding part is integral with said flange;
said securing means, said resilient part and said holding part are integral, in that said flange has a rotational symmetry and in that said resilient part comprises an annular ridge joining said securing means and said holding part;
said annular ridge has a cross-section, along a plane comprising said axis of rotation, having the shape of half an ellipse.
said holding part has a hole, said sensing element being mounted through said hole;
said sensing element is arranged to be mounted on or removed from said holding part along a generally radial direction with respect to said axis of rotation;
said sensing element is individually removable from said flange assembly;
said holding part encases said outer ring;
said securing means comprise an annular plate and a plurality of holes bored through said annular plate;
said sensing element is arranged to read said target along a radial direction with respect to said axis of rotation;
said sensing element is arranged to read said target along an axial direction with respect to said axis of rotation;
said sensing element is selected in the group comprising a magnetic sensor, a capacitive sensor, an inductive sensor and an optical sensor; and
said resilient part comprises an elastic washer.

### BRIEF DESCRIPTION OF THE DRAWINGS

The present invention and its advantages will be well understood on the basis of the following description, which is given as an illustrative example without restricting the scope of the invention and in relation with the annexed drawings, among which:

FIG. 1 is a perspective view of a flange assembly according to the invention,

FIG. 2 is an exploded perspective view of the flange assembly of FIG. 1, and

FIG. 3 is a cross-section along plane III on FIG. 1.

### DETAILED DESCRIPTION OF SOME EMBODIMENTS

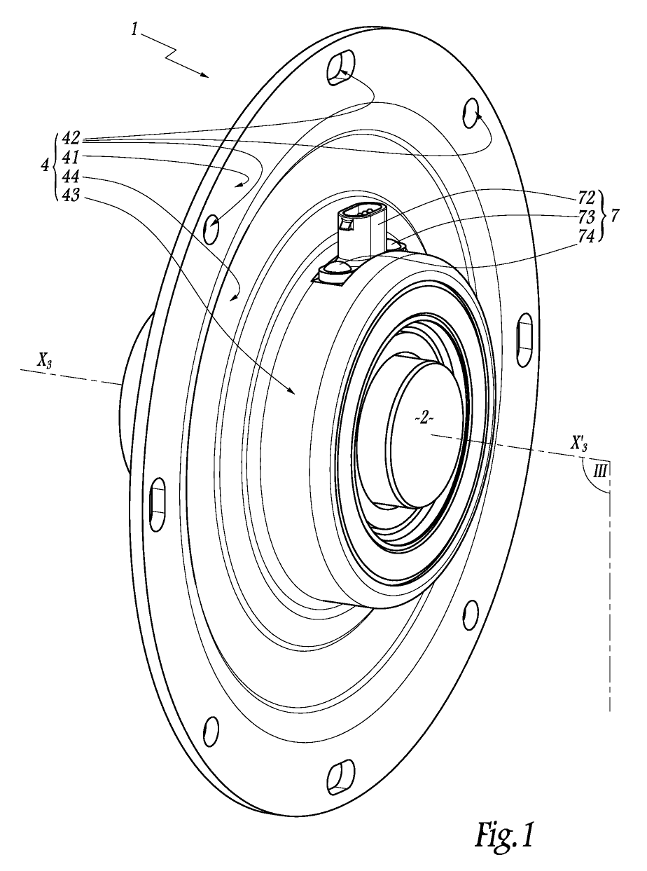

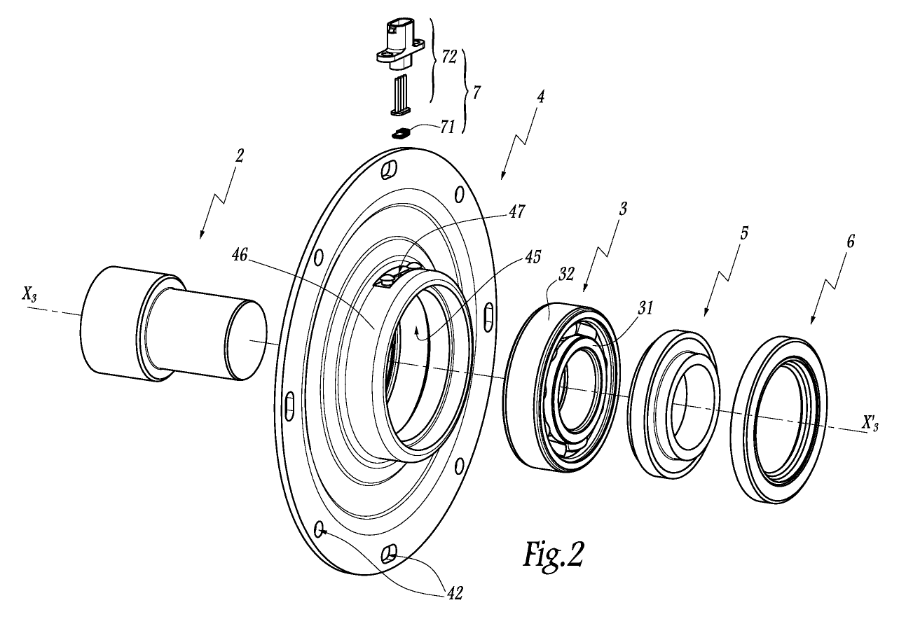

FIGS. 1 and 2 illustrate a flange assembly 1, respectively after and before its assembly. Flange assembly 1 comprises a rolling bearing 3, a flange 4 and a sensing element or sensor 7. Flange 4 has a rotational symmetry around axis X₃-X′₃.

The rolling bearing 3 has balls 33, an inner ring 31 and an outer ring 32. Inner ring 31 is rotatable around an axis of rotation X₃-X′₃. The annular, inner radial surface of inner ring 31 receives an end portion of a rotatable shaft 2. Rolling bearing 3 is mounted into flange 4.

Flange assembly 1 further comprises a holding part 43 to hold rolling bearing 3 and sensor 7. As can be seen on FIG. 2, holding part 43 has a cavity 45 of a cylindrical shape to encase the annular, radial outer surface of the outer ring 32. Holding part 43 thus encases the outer ring 32.

Flange 4 comprises a plate 41 of a flat, annular shape extending radially with respect to axis X₃-X′₃, i.e. along an axis Y₃-Y′₃. On the side of axis X₃-X′3, plate 41 ends up with a shoulder 411 serving as a positioning reference. Flange 4 also comprises several holes 42 bored through plate 41 at locations which are approximately evenly distributed around axis X₃-X′₃. The holes 42 are bored parallel to axis X₃-X′₃.

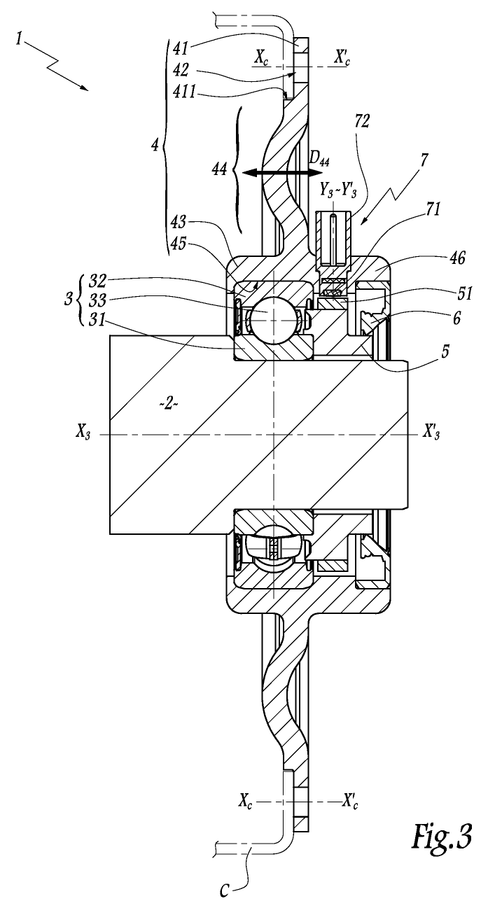

Plate 41 and holes 42 form securing means for securing flange assembly 1 to a static casing C, partially sketched by a dashed line at FIG. 3. Such a static casing C is intended to house the rotatable shaft 2. For instance, such a static casing C can be a motor casing for housing a motor, or any other mechanical system such as a gearbox or an actuator.

In order to secure flange 4 to the static casing C, plate 41 can be pressed against a not shown corresponding plate, while screws or bolts, schematically shown at FIG. 3 with reference X_{C}-X′_{C}, pass through the holes 42 to fasten flange assembly 1 to the static casing C. Holding part 43 is hence configured to hold the outer ring 32.

Sensor 7 comprises an electrical connector 72 and a sensing member 71. As can be seen on FIG. 3, after assembly of flange assembly 1, sensing member 71 is arranged to read a target 51. In the example of the FIGS. 1, 2 and 3, the sensor 7 is of a magnetic type. The sensing member 71 can comprise a Hall effect cell and the target 51 can be a magnetized multipolar ring. Connector 72 can receive a plug not shown to supply electrical power to the sensing member 71 and deliver sensing signals to a not shown remote control unit.

Sensor 7 is mounted through a hole 47 visible on FIG. 2. Hole 47 is bored through an exterior portion 46 of holding part 43 along a radial direction Y₃-Y′₃ with respect to axis X₃-X′₃. Sensor 7 is arranged to be mounted on or removed from holding part 43 along radial direction Y₃-Y′₃. As can be seen on FIGS. 1 and 2, connector 72 of sensor 7 is fastened to the exterior portion 46 by means of two screws 73 and 74. The terms “interior” and “exterior” respectively refer to the inside and to the outside of the static casing C. The term “inner” relates to an element oriented towards axis X₃-X′₃, whereas the term “outer” relates to an element oriented opposite to axis X₃-X′3.

Sensor 7 is individually removable from flange assembly 1, i.e. without removing any other component of flange assembly 1. Besides, in order to remove sensor 7 from outside the static casing C, an operator only needs to unscrew screws 73 and 74. Alternatively to screws, snapping means can advantageously be used to lock the sensor 7 in position. Sensor 7 is thus easily removable from outside the static casing C. The outside of the static casing C is represented by the right-hand part of FIG. 3.

The target 51 is attached to the inner ring 31. More accurately, target 51 is fixed on a support member 5, which is fast with inner ring 31. Target 51 can be stuck or tight-fitted onto the radial outer surface of support member 5. Thus, the sensing member 71 of the sensor 7 is arranged to read target 51 along a radial direction with respect to axis X₃-X′₃. The sensor therefore measures a rotational parameter of the flange assembly.

Flange assembly 1 further comprises an annular ridge 44 joining the plate 41 and the holding part 43. Like the flange 4, the annular ridge 44 has a rotational symmetry around axis X₃-X′₃. The cross-section of annular ridge 44 along plane Ill has the shape of half an ellipse. The plate 41, the annular ridge 44 and the holding part 43 are integral. Therefore, annular ridge 44 is integral with flange and holding part 43 is integral with flange 4.

The dimensions of annular ridge 44, in particular its thickness along axis X₃-X′₃, are selected so that the annular ridge 44 can have an elastic deformation along axis X₃-X′₃, as indicated by the double arrow D₄₄ at FIG. 3. The annular ridge 44 thus forms a resilient part arranged to elastically urge holding part 43 with respect to plate 41 and holes 42 and generally along axis X₃-X′₃.

Annular ridge 44 hence enables to preload the rolling bearing 3, in particular its outer ring 32. Such a preloading of rolling bearing 3 permits to avoid any unnecessary clearance inside the bearing, so that the bearing rotates smoothly and quietly. For instance, in case the rolling bearing 3 is a Deep Groove Ball Bearing, a flange assembly according to the invention ensures that a small axial preloading is applied onto the bearing.

Flange assembly 1 further comprises a sealing gasket 6 mounted into the outside portion of holding part 43 so as to hinder leaks of lubricant out of the static casing and to prevent ingress of water or dust in the static casing.

Thus, a flange assembly according to the invention provides easy access to the sensor for its removal or replacement, hence a high serviceability of the sensor.

Furthermore, a flange assembly according to the invention permits to preload the rolling bearing, hence to increase its service life.

Besides, since the sensor and the target are both fixed with respect to the holding part, they move together without significantly varying the sensing gap between them. This increases the sensor accuracy, and thereby the precision of the measurement.

According to a not shown embodiment, the resilient part can comprise an elastic washer forming a resilient part, instead of annular ridge 44. Such an elastic washer can be located between the securing means, i.e. annular plate and the static casing.

Alternatively to a magnetic encoder, the sensor can be selected in the group consisting of a capacitive sensor, an inductive sensor and an optical sensor.

According to a not shown embodiment of the present invention, the sensor can comprise several sensing members and can be arranged to read one or several targets along an axial direction or along a direction sloped to the axis of rotation.

According to another not shown embodiment, a flange assembly according to the present invention can comprise a blind plummer block to receive the end of a shaft so as to form a flange corresponding to the flange 4.

According to a further not shown embodiment of the present invention, the flange assembly can house a middle portion of a shaft, instead of the end of a shaft.

The invention has been described in relation with a rolling bearing having balls as rolling components. However, the invention also applies to other types of rolling components, like rollers or needles for instance.

1. A flange assembly (1), for holding a portion of a rotatable shaft (2), comprising:
a rolling bearing (3) having an inner ring (31) and an outer ring (32), said inner ring (31) being rotatable around an axis of rotation (X₃-X′₃),
a target (51) attached to said inner ring (31),
a sensing element (7) arranged to read said target (51),
a flange (4) having securing means (41, 42) for securing said flange assembly (1) to a static casing (C), and wherein
said flange assembly (1) further comprises:
a holding part (43) configured to hold said outer ring (32),
a resilient part (44) arranged to elastically urge said holding part (43) with respect to said securing means (41, 42) and generally along said axis of rotation (X₃-X′₃), and wherein
said sensing element (7) is attached to said holding part (43) so as to be removable from outside said static casing (C).

2. The flange assembly (1) according to claim 1, wherein said resilient part (44) is integral with said flange (4).

3. The flange assembly (1) according to claim 2, wherein said holding part (43) is integral with said flange (4).

4. The flange assembly (1) according to claim 3, wherein said securing means (41, 42), said resilient part (44) and said holding part (43) are integral, in that said flange (4) has a rotational symmetry and in that said resilient part comprises an annular ridge (44) joining said securing means (41, 42) and said holding part (43).

5. The flange assembly (1) according to claim 4, wherein said annular ridge (44) has a cross-section, along a plane (III) comprising said axis of rotation (X₃-X′₃), having the shape of half an ellipse.

6. The flange assembly (1) according to claim 5, wherein said holding part (43) has a hole (47), said sensing element (7) being mounted through said hole (47).

7. The flange assembly (1) according to claim 6, wherein said sensing element (7) is arranged to be mounted on or removed from said holding part (43) along a generally radial direction with respect to said axis of rotation (X₃-X′₃).

8. The flange assembly (1) according to claim 7, wherein said sensing element (7) is individually removable from said flange assembly (1).

9. The flange assembly (1) according to claim 1, wherein said holding part (43) encases said outer ring (32).

10. The flange assembly (1) according to claim 1, wherein said securing means (41, 42) comprise an annular plate (41) and a plurality of holes (42) bored through said annular plate (41).

11. The flange assembly (1) according to claim 1, wherein said sensing element (7) is arranged to read said target (51) along a radial direction (Y₃-Y′₃) with respect to said axis of rotation (X₃-X′₃).

12. The flange assembly (1) according to claim 1, wherein said sensing element is arranged to read said target along an axial direction with respect to said axis of rotation.

13. The flange assembly (1) according to claim 1, wherein said sensing element (7) is selected in the group comprising a magnetic sensor (7), a capacitive sensor, an inductive sensor and an optical sensor.

14. The flange assembly (1) according to claim 1, wherein said resilient part comprises an elastic washer.
